(19) United States
(12) Patent Application Publication
(10) Pub. No.: US 2013/0319238 A1
(43) Pub. Date: Dec. 5, 2013

(54) Gas Purifying Device for Energy Saving and Preventing Spraying Waste Water Indiscriminately and Method Thereof

(71) Applicants: Tszwa LEUNG, (US); Kwongkeung LEUNG, (US)

(72) Inventors: Tszwa Leung, Hong Kong (CN); Kwongkeung Leung, Hong Kong (CN)

(21) Appl. No.: 13/989,387

(22) PCT Filed: Nov. 23, 2010
(86) PCT No.: PCT/CN2010/078983

§ 371 Date: Aug. 23, 2013

(51) Int. Cl. B01D 47/02

(52) U.S. Cl. CPC B01D 47/021
USPC 95/226; 96/351

(57) ABSTRACT

A gas purifying device for energy saving and preventing spraying waste water indiscriminately includes: a container (103) containing a proper quantity of purifying liquid; a waste gas incoming pipe (101) having a channel mouth (102) for introducing waste gas, wherein the channel mouth (102) is contacted with and provided in the purifying liquid in the container (103) and is submerged by the purifying liquid; and safe gas discharge channels (107, 109) for purified gas. A cross-sectional area of a narrowest part of the safe gas discharge channel (107, 109) is greater than a smallest part of the waste gas incoming pipe (101), so as to ensure a smooth operation of the gas discharge channel. The gas purifying device solves problems of regular engine flameout due to the non-smooth gas discharge of a purifier and environmental pollution caused by spraying waste water indiscriminately in the purifier working process.

### CROSS REFERENCE OF RELATED APPLICATION

This is a U.S. National Stage under 35 U.S.C 371 of the International Application PCT/CN2010/078983, filed Nov. 23, 2010.

### BACKGROUND OF THE PRESENT INVENTION

1. Field of Invention

The present invention relates to a gas purifying device for energy saving, avoiding wasting purified water, preventing spraying waste water indiscriminately, and avoiding polluting the environment by waste water, and a method thereof.

2. Description of Related Arts

A Chinese patent with a publication number of CN2093904U “automotive exhaust emission purifier” discloses an automotive exhaust emission purifier having a seal-capping fluid container, a diameter of a waste gas incoming pipe (9) thereof is obviously the same with a diameter of a gas discharge pipe (21) for purified gas thereof. For this kind of gas purifying device, experiment has shown us that without resistance of external liquid and vapor, the flow pressure of hot waste gas discharged by automobiles has a strong discharging speed. However, if the original discharge pipe is connected to the seal-capping fluid container of the automotive exhaust emission purifier according to CN2093904U when restarting, since the diameter of the waste gas incoming pipe (9) is the same with the diameter of the gas discharge pipe (21) for the purified gas, the gas discharge pipe (21) for the purified gas is not predesigned for that partial liquid in the container turns into water vapor and then is taken from the container to emission spaces in the air, under triple resistance of liquid and water vapor in the container, and lack of correspondingly widened gas discharge channel for purified gas, the automobile is difficult to start, or flameout often occurs after starting. Furthermore, when the automobile is started and begins to operate at full speed, the flow of waste gas generated thereby pushes liquid of waste water to spray out of the container easily from a full liquid hole (17) for preventing emission of gas and the gas discharge pipe (21) for the purified gas, which not only affects the normal operation of the automobile, but also has problems that: another type of disastrous waste water is generated, which contaminate the environment and thus is a technical defect; each vehicle generates tons of waste water per day; the cost of waste water is more than the cost of fuel; and the emission of waste gas is not smooth which affects traffic safety. Therefore, this kind of gas purifying device is completely lack of practical usage for environmental protection. In addition, in a patent US005143527A and other materials of similar gas purifying device, the specifications have not directly and unambiguously disclosed that the purifying device thereof has technical characteristics besides preventing spraying of waste water, and the waste gas purifying device thereof has a suction exhauster not only installed on a waste gas incoming pipe before purification, but also on gas discharge channel after purification above the water line in the container, which not only wastes electricity, but also discharges the waste water in the container out of the container, and causes problems that the cost of waste water is more than fuel, disastrous waste water is generated and is transformed into waste gas which contaminates the environment and thus is a technical defect. Therefore the waste gas purifying devices disclosed thereof all have no practical and universal effect on protecting the environment, so people have never had confidence and hope on the environmental effectiveness of treating soot pollutions generated by all walks of life.

### SUMMARY OF THE PRESENT INVENTION

In view of the technical defect problem of the waste gas purifying device, the problem of a more cost of waste water than the cost of fuel thereof, and the problem of wasting electricity disclosed above by the references. A technical solution of the present invention is to increase a proportion of a cross-sectional area of a narrowest part of a purified gas discharge channel after purification in the container, in such a manner that the proportion thereof is greater than a proportion of a cross-sectional area of a narrowest part of the waste gas incoming pipe before purification, so as to prepare sufficient space for dispersing pressure of gas after purification, so as to discharge the gas and water vapor out of the container freely, prevent the waste water from spraying out of the container, and ensure that the original smooth operation effect of the gas discharge pipe is not affected. The present invention thoroughly solves the technical problems of wasting plenty of water and spraying waste water indiscriminately to pollute the environment, which exists in the purifying device of a patents CN2093904U and US005143527A, and other similar waste gas purifying device. Furthermore, the present invention also solves universal problems of pollution of various waste gas, e.g., industrial emissions discharged by automobile or all walks of life, soot generated by burning of grasses on farmland, smoke in the kitchen of each house, soot of garbage furnace, powder of grinding and cutting engineering, air pollutants of dust indoors and outdoors, foul smell from places of livestock, foul smell of washroom, smog generated in burning joss sticks or turning undesirable into a resource and etc can all be solved by technique of the present invention. In addition, the device provided by present invention is capable of preventing wasting water.

A technical solution provide by the present invention is as follows.

A gas purifying device for energy saving and preventing spraying waste water indiscriminately, comprises:

a container containing a proper quantity of purifying liquid,

a waste gas incoming pipe of the container, which has a channel mouth for introducing waste gas, wherein a first end of the waste gas incoming pipe is provided outside the container, so as to contact with the waste gas outside the container, a second end of the waste gas incoming pipe, is provided in the purifying liquid in the container, and is submerged by the purifying liquid,

an eliminator for guard provided above a water line in the container, wherein from a top view, the eliminator is covered on and has a greater area than the waste gas discharge mouth before purification and a space above the water line and the purifying water surrounding the waste gas discharge mouth before purification, and

a suction exhauster provided on the waste gas incoming pipe before purification,

wherein the container has a safe gas discharge channel for purified gas, and a cross sectional area of a narrowest part of the safe gas discharge channel for purified gas is over one time greater than a narrowest part of the waste gas incoming pipe provided before purification.

Another technical solution provide by the present invention is as follows.

A gas purifying device for energy saving and preventing spraying waste water indiscriminately, comprises:

a container containing a proper quantity of purifying liquid,

a waste gas incoming pipe before purification having a channel mouth for introducing waste gas, which is provided in and contacted with the purifying liquid in the container, and is submerged by the purifying liquid, and

a safe gas discharge channel for purified gas, wherein a cross sectional area of a narrowest part of the safe gas discharge channel for purified gas is over one time greater than a narrowest part of the waste gas incoming pipe provided before purification.

The technical solution mentioned above further comprises characteristics as follows.

The device is made of metal, nonmetal or mixed materials.

A gas filter is provided in the gas discharge channel.

The waste gas incoming pipe having the channel mouth before the container for purifying liquid is connected on covers and machines for collecting smoke or dust.

The waste gas incoming pipe having the channel mouth is communicated with various waste gases.

An eliminator is provided above the purifying liquid and the safe gas discharge channel in the container, the eliminator can adopt one layer or more than one layer, and after the eliminator is provided, a cross sectional area of the gas discharge channel must be over one time greater than a narrowest part of the waste gas incoming pipe before purification.

The device further comprises an upper eliminator and a lower eliminator provided above the water line of the container, wherein separate spaces on an upper layer or a lower layer of the upper eliminator and the lower eliminator extend above or below each other, a cross sectional area of the gas discharge channel must be over one time greater than a narrowest part of the waste gas incoming pipe before purification.

The device further comprises a water stop sheet installed on the water line of the waste gas incoming pipe before purification, the water stop sheet is installed in the same way as the eliminator, extending from an inner edge of the water line of the waste gas incoming pipe towards a space in the channel from above to below, a sufficient space of the gas discharge channel is reserved, and the water stop sheet can adopt one layer or more than one layer.

A pipe of the gas discharge channel for purified gas is in a bending shape or a non-bending shape.

A suction exhauster is provided in the waste gas incoming pipe before purification.

The purifying water in the container further comprises alkaline matter and nitride added therein.

The purifying water in the liquid container further comprises cleaning agent of dishwashing liquid.

A method for energy saving and preventing spraying waste water indiscriminately provided by the present invention comprises:

installing a suction exhauster in a channel of a waste gas discharge pipe before purification, wherein the suction exhauster is installed in and contacted with a liquid container from a mouth at a first end of a waste gas incoming pipe outside the container, and a mouth at a second end of a waste gas discharge channel which is submerged by liquid forces a waste gas flow to pump into purifying liquid in a container containing a proper quantity of purifying liquid, by taking advantage of interaction and full contaction of the gas flow and the purifying liquid in the liquid container, the gas flow is thoroughly filtered and purified, then purified gas is discharged out of the container from a safe gas discharge channel after purification which has a greater area than a narrowest part of the waste gas incoming pipe provided before the purifying liquid of the container.

Another method for energy saving and preventing spraying waste water indiscriminately provided by the present invention comprises: installing a suction exhauster in a channel of a waste gas discharge pipe before purification, wherein the suction exhauster is installed in and contacted with a liquid container from a mouth at a first end of a waste gas incoming pipe outside the container, and a mouth at a second end of a waste gas discharge channel which is submerged by liquid forces a waste gas flow to pump into purifying liquid in a container containing an eliminator and a proper quantity of purifying liquid, by taking advantage of interaction and full contaction of the gas flow and the purifying liquid in the liquid container, the gas flow is thoroughly filtered and purified, then purified gas is discharged out of the container from a safe gas discharge channel after purification which has a greater area than a narrowest part of the waste gas incoming pipe provided before the purifying liquid of the container,

wherein the eliminator in the container is provided in the safe gas discharge channel after purification and on the water line of the purifying liquid,

from a top view, the eliminator is covered on and has a greater area than the waste gas discharge mouth before purification and a space above the water line and the purifying water surrounding the waste gas discharge mouth before purification,

the eliminator can adopt one layer or more than one layer, and when the eliminator is provided more than one layer,

separate spaces on an upper layer or a lower layer of the upper eliminator and the lower eliminator extend above or below each other, a cross sectional area of the gas discharge channel must be over one time greater than a narrowest part of the waste gas incoming pipe before purification.

The methods mentioned above further comprise characteristics as follows.

A gas filter is provided in the gas discharge channel.

The purifying water in the liquid container further comprises alkaline matter and nitride.

A sand grain filter is provided in the gas discharge channel.

A carbon grain filter is provided in the gas discharge channel.

These and other objectives, features, and advantages of the present invention will become apparent from the following detailed description, the accompanying drawings, and the appended claims.

### BRIEF DESCRIPTION OF THE DRAWINGS

FIGS. 1˜3 are sketch views of three structures of the present invention, wherein FIG. 2b is a top view of a lower eliminator of FIG. 2a.

In the figs: 101—waste gas incoming pipe, 102—channel mouth for introducing waste gas, 103—liquid container, 104—waste gas and pollutants discharge mouth, 105—liquid water line, 106—purified gas discharge mouth, 107—safe gas discharge channel, 108—lower eliminator, 109—safe gas discharge channel, 110—upper lower eliminator, 111—purified liquid introducing and controlling switch.

### DETAILED DESCRIPTION OF THE PREFERRED EMBODIMENT

Combining with the accompanying drawings and the preferred embodiments, further description of the present invention is illustrated in detail.

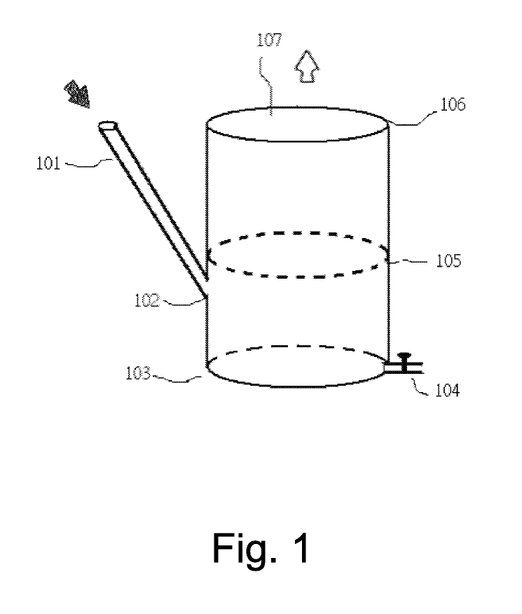

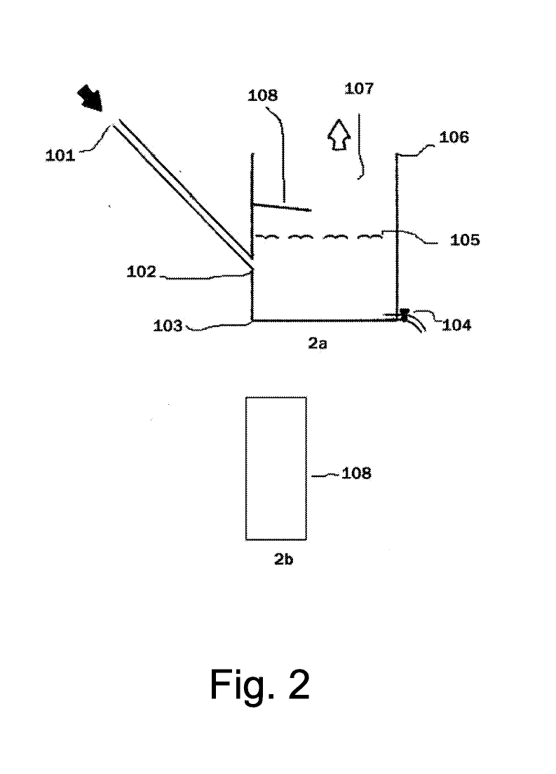

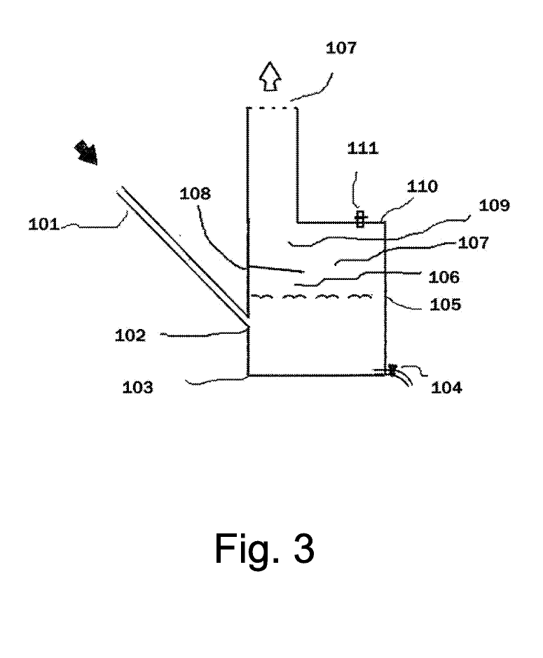

According to a first preferred embodiment of the present invention, a gas purifying device for energy saving and preventing spraying waste water indiscriminately as shown in FIG. 1 of the drawings comprises:

a container 103 containing a proper quantity of purifying liquid, which is for collecting pollutants of waste gas and purifying waste gas,

a waste gas incoming pipe 101 having a channel mouth 102 for introducing waste gas before purification, which is contacted with and provided in purifying liquid 105 in the container 103 and is submerged by the purifying liquid,

a gas discharge channel below a water line of the container, and a safe gas discharge channel 107 for purified gas above the water line, wherein a cross-sectional area of the gas discharge channel and the safe gas discharge channel 107 is greater than a smallest part of the waste gas incoming pipe provided before gas purifying, so as to disperse gas-flow pressure introduced thereof in such a manner that purified gas and purified water vapor is capable of discharging out of the container 103 in a wide channel freely, so as to prevent gaseous pollutants recycled and collected in the container 103 and waste water polluted by the gaseous pollutants from discharging out of the container by gases thereof; prevent the waste water from polluting the environment, avoid water wastage and ensure that original smooth operation of the gas discharge channels is not impact. In the FIG. 1 of the drawings, number 106 shows a gas discharge opening on a top of a periphery shell above the water line of the container 103, i.e., the safe gas discharge channel 107 for purified gas of the container 103. In the FIG. 1, a diameter of the cylindrical container 103, i.e., a cross sectional area of the safe gas discharge channel 107 for the purified gas of the container 103 is much greater than the waste gas incoming pipe 101. In the FIG. 1, reference number 104 is an element for discharging pollutants of waste water, which is added on a bottom portion of the container 103 and has a control function of switching on and off. In the FIG. 1, reference number 105 is specific identification information indicating water level of the purifying liquid of the container 103, i.e. the water line. The greater the distance between the water line 105 and the gas discharge opening 106 on the top of the container 103 for the purified gas, the less risk the spray of waste water, or even no spray of waste water. The distance therebetween can be selected according to actual requirements such as 5 cm, over 5 cm or approximating 5 cm.

According to a second preferred embodiment of the present invention, referring to FIG. 2 of the drawings, a gas purifying device for energy saving and preventing spraying waste water indiscriminately, comprises:

a container 103 containing a proper quantity of purifying liquid, which is for collecting pollutants of waste gas and purifying waste gas, and

a waste gas incoming pipe 101 having a channel mouth 102 for introducing waste gas before purification, which is contacted with and provided in purifying liquid 105 in the container 103 and is submerged by the purifying liquid.

In the FIG. 2 of the drawings, reference number 104 is an element for discharging pollutants of waste water, which is added on a bottom portion of the container 103 and has a control function of switching on and off.

In the FIG. 2 of the drawings, reference number 106 is a top of a periphery shell of the container 103, i.e., an opening of a safe gas discharge channel 107 for purified gas of the container 103, which is higher than a water line 105 and a low eliminator 108 of the container 103, so as to prevent liquid in the container from spraying out of the container 103 under pressure of gases. The safe gas discharge channel 107 for purified gas of the container 103 is beside the eliminator 108, and a cross sectional area of a narrowest part of the safe gas discharge channel 107 is greater than a narrowest part of an opening of the waste gas incoming pipe 101 before purification, so as to disperse gas flow pressure introduced thereof, in such a manner that purified gas and purified water vapor is capable of discharging out of the container 103 in a wide channel freely, so as to prevent gaseous pollutants recycled and collected in the container 103 and waste water polluted by the gaseous pollutants from discharging out of the container by gases thereof; prevent the waste water from polluting the environment, avoid water wastage and ensure that original smooth operation of the gas discharge channels is not impacted. In the FIG. 2 of the drawings, reference number 108 is one-layer eliminator. The eliminator is optionally provided on the water line 105 of the container 103, and extend to space in the container 103 horizontally or from above to below. Under a top view, the eliminator has a greater area than and is covered on a space of the channel mouth 102 for introducing waste gas before purification and a space above the purifying liquid water line in the periphery. Sufficient distance should be provided between the low eliminator 108 and the water line 105, such as 10 cm, over 10 cm or approximately 10 cm, so as to be blocked by the waste water impulsed upwardly by gas flow discharged by the waste gas discharge channel as much as possible, and reflux downwardly in the container, in such a manner that gases and the liquid has sufficient separating space, gases flows around the eliminator from a space below the eliminator and is discharged out of the container from the safe gas discharge channel 107 on the other side, i.e., both the distance between the eliminator and the water line and a cross sectional area of the safe gas discharge channel 107 for purified gas should be greater than a cross sectional area of a narrowest part of the waste gas incoming pipe before purifying, so as to disperse gas flow pressure introduced thereof for purified gas and purified water vapor being capable of discharging out of the container 103 in a wide channel freely, and prevent waste water in the container 103 from being forced out of the container by the gas. In the FIG. 2 of the drawings, the container shown therein can be a cylinder-shaped body, a cube, a rectangular parallelepiped or various shaped body. The eliminator 108 can be optionally manufactured to be various shapes such as rectangle (see FIG. 2b), semi-circular or various shapes to be matched with the container 103.

When the one-layer eliminator is provided in the container, the distance between the eliminator and the water line is as important as the cross-sectional area of the gas discharge channel for the purified gas. The greater the ratio of the cross-sectional area of the gas discharge channel for the purified gas to the cross-sectional area of the narrowest part of the waste gas incoming pipe before purification, the less risk the spray of waste water, or even no spray of waste water.

According to a third preferred embodiment of the present invention, referring to FIG. 3 of the drawings, a gas purifying device for energy saving and preventing spraying waste water indiscriminately comprises:

a gas purifying device for energy saving and preventing spraying waste water indiscriminately, comprises:

a container 103 containing a proper quantity of purifying liquid, which is for collecting pollutants of waste gas and purifying waste gas,

a waste gas incoming pipe 101 having a channel mouth 102 for introducing waste gas before purification, which is contacted with and provided in purifying liquid 105 in the container 103 and is submerged by the purifying liquid, and

a safe gas discharge channel 107 for purified gas of the container 103 and an opening thereof, wherein a cross sectional area of a narrowest part of the safe gas discharge channel 107 is greater than a narrowest part of an opening of the waste gas incoming pipe 101 before purification, so as to disperse gas flow pressure introduced thereof, in such a manner that purified gas and purified water vapor is capable of discharging out of the container 103 in a wide channel freely, so as to prevent gaseous pollutants recycled and collected in the container 103 and waste water polluted by the gaseous pollutants from discharging out of the container by gases thereof; prevent the waste water from polluting the environment, avoid water wastage and ensure that original smooth operation of the gas discharge channels is not impact.

In the gas purifying device for energy saving and preventing spraying waste water indiscriminately as shown in FIG. 3 of the drawings, reference number 101 is a non-vertical and slant type waste gas incoming pipe of the container 103, which can be in a shape of a cylinder, a square pail or a slant cylinder and etc. The waste gas incoming pipe 101 before purification and an opening thereof can be manufactured to have the same diameter as thereof a waste gas discharge pipe of various oil-fed generators according requirements, so as to be connected and matched therewith. The waste gas incoming pipe 101 before purification and the opening thereof can also be manufactured to be connected and matched with various trumpet and non-trumpet type suction exhauster and a channel thereof for collecting smoke, dust and various polluted gases. Extending pipes of the container and a waste gas discharge channel thereof, can extend from outside the container at a height above the water line into the container at a height below the water line and is submerged by liquid, or contact the liquid in the container and is submerged thereby from a periphery outside the container and above the water line as well, which is shown in the FIG. 3 as a reference number 102. The waste gas incoming pipe 101, which extends into and contacts the container at the height below the water line and is submerged thereby, can be optionally in a vertical up-and-down type or a non-vertical type. The non-vertical type (slant type), which is shown as the reference number 102 in the FIG. 3, is optionally horizontal, upward buckling and etc. Compared with the vertical type, the slant type waste gas incoming pipe is more energy saving and smoother for gas discharging.

The reference number 102 in FIG. 3 is a waste gas incoming channel mouth 102, which is capable of introducing all of the waste gas before purification into the purifying liquid in the container and processing an over all purifying treatment. In the FIG. 3 of the drawings, the reference number 103 is a container containing a proper quantity of purifying liquid, which is used for collecting pollutants and purifying gases, a cross sectional area of the container 103 is 50 times, over 50 times or below 50 times of a cross sectional area of a narrowest part of the waste gas incoming pipe (101) before purification, so as to provide strong flow of the incoming waste gas with an instantly sufficient space for dispersing atmospheric pressure thereof, so as to depart from the liquid and pass through the a safe gas discharge channel (107, 109) for purified gas, and mouths thereof, so as to discharge out of the container. In the FIG. 3, the container containing a property quantity of purifying liquid can be in a shape of a cylinder, a square barrel and etc. In the FIG. 3 of the drawings, reference number 104 is an element for discharging waste water and pollutants additionally provided in a lowest portion of the container 103, which has a controlling effect of switch on and off. In the FIG. 3, the reference number 105 is specific identification information indicating water level of the purifying liquid of the container 103, i.e. the water line. In the FIG. 3, reference number 106 shows a space of gas discharge channel pre-provided between the water line 105 of the purifying liquid in the container 103 and the lower eliminator, and a cross sectional area thereof should be greater than a cross sectional area of a narrowest part of the waste gas incoming pipe 101 before purification, so as to decrease resistance of discharging gas freely. In the FIG. 3, reference number 107 is a safe gas discharge channel for purified gas provided on each other beside the lower eliminator, wherein a cross-sectional area thereof should be greater than a cross-sectional area of a narrowest part of the waste gas incoming pipe 101 before purification, so as to ensure that an original effect of discharging freely in operation is not impact. Reference number 110 is a design of an upper eliminator optionally provided above the water line in the container and in each other of the lower eliminator 108, and an effect of the upper eliminator is the same as the lower eliminator 108, which serves not only as an upper portion of a cover of the container, but also as an eliminator, in such a manner that the purifying liquid in the container can not spray out of the container by force of gas, and that the waste water in the container is prevented from running out of the container while the container is shaking, so that the environment is polluted. The container comprises at least one layer of eliminator, wherein separate spaces on an upper layer or a lower layer of the upper eliminator and the lower eliminator extend above or below each other, so as to provide sufficient space for the purified gas to discharge freely, i.e., a cross sectional area of the gas discharge channel must be over one time greater than a narrowest part of the waste gas incoming pipe before purification, so as to prevent the waste water in the container from spraying out of the container and polluting the environment, and ensure that an effect of discharging freely of the purified discharge channel in operation is not impact. The eliminator in the container should be provided in various transportation vehicles and other vehicles, which has an effect of buffering, in such a manner that liquid impulsed by gas reflows to the liquid container, in such a manner that the gas is separated from the liquid and is discharged out of the container. If a distance between the purified gas discharge mouth on a periphery plate above the water line of the container and the water line is large enough, the eliminator can be omitted and not provided, but it is difficult to have an extensive application of the purifying device. In the FIG. 3 of the drawings, reference number 108 shows a horizontal eliminator from a top view, which is provided above the water line of the mouth of the waste gas discharge channel 102 below the water line, and the horizontal eliminator is covered on the mouth of the waste gas discharge channel 102 and approximately a half of a space above the water line on a periphery of 102, and an area of the horizontal eliminator is greater than mouth of the waste gas discharge channel 102, so as to block scattered waste liquid impacted upwardly by strong gas flow discharged by the mouth of the waste gas discharge channel 102, in such a manner that the liquid flows back downwardly or scatters to a periphery space of the container. Due to the impact of the gas flow, a first part of the liquid in the container rushes out of a surface of the liquid and is blocked back to a position below the water line by the lower eliminator 108, a second part of the liquid therein forms water breaking film wave, and is impacted by gas flow to pass through a space of the gas discharge channel 107 besides the eliminator, and is impacted upwardly again. The second layer eliminator 110 plays a complementary role in blocking liquid impacted by the gas flow for a second time and sprayed out of the container, so as to block the liquid back into the container, prevent the waste water in the container from spraying out of the container under force, in such a manner that the gas and the liquid is charged out of the container 103 via the safe gas discharge channels 107 and 109 after purification freely after being fully separated. The eliminator can adopt one layer or multi-layers. It is especially important to install an eliminator in purifying devices such as household kitchen fume purification device, smoke purification device for smokers, smoke purification device for temples, automotive fume purification device, indoor and outdoor harmful bacterial contamination gas purification device, and other large and medium small scaled dust purification device. In the FIG. 3, reference number 111 is an element for introducing purified liquid and on-off controller thereof, which can be selectively provided on a shell of the container 103. Further more, the safe gas discharge channel can also be used for introducing water or various purifying liquid temporarily for convenience during non-gas purification operation. Moreover, it is better to install fixed purifying liquid introducing equipment in a purifying device.

In the FIG. 3 of the drawings, a discharge mouth of the waste gas incoming pipe before purification is connected and contacted with an inner wall of the container, and is provided on a side face of the inner wall of the container below the water line, can also extend to a middle position or other positions in the container below the water line by taking advantage of the waste gas incoming pipe 101 before purification, and is positioned in a direction of side style, top view style, bottom view style, oblique view style and etc.

The thickness of liquid submerging the discharge mouth of the waste gas incoming pipe before purification can be optionally 5 cm, over 5 cm or below 5 cm.

Orientation of the discharge mouth 106 of the gas discharge channel 107 after purification in the container 103 can be set to face the sky or on the side face.

Besides the manner of 108 and 110 shown in the drawings, in the gas purifying device for energy saving and preventing spraying waste water indiscriminately provided according to another preferred embodiment, the eliminator can be provided in a position of the discharge mouth of the waste gas incoming pipe before purification in the container according to requirements, e.g., the discharge mouth of the waste gas incoming pipe is provided on an N position of an inner peripheral below the water line of the container. Accordingly, the eliminator can be provided on the discharge mouth of the waste gas incoming pipe, or on a position 10 cm, over 10 cm or below 10 cm from water surface. If the discharge mouth of the waste gas incoming pipe is provided in a middle portion of the water line of the container, the eliminator can accordingly be provided on a middle portion above the water surface of the container. An object of providing the eliminator is to block liquid impacted by gas flow back to the container, and to provide a certain space for the purified gas and liquid to separate, in such a manner that purified gas is discharged out of the container from bottom to up via a space surrounding the eliminator, i.e., gas discharge channel after purification, so as to prevent the purifying device from spraying waste water indiscriminately to pollute the environment. The eliminator can be provided on an appropriate position such as two sides, a periphery or a middle portion of the container, and is connected therewith via an appropriate support. The eliminator can be made into a slant shape, a flat plate shape, a wave shape, a square shape, a round shape, rectangular shape and various other shapes. However, the shape of the eliminator should be selected according to a size of the container and an actual shape of the gas discharge channel after purification. The eliminator only selects a one-layer type. The eliminator is provided and covered on the discharge mouth of the waste gas incoming pipe before purification under the water line, and on a position both above the water surface and below the discharge mouth of the gas discharge channel after purification of the container, so as to provided an efficient space for the purified gas to discharge upwardly out of the container, and prevent the scattered waste water impacted from bottom to top by strong gas from spraying out of the container, so as to avoid a secondary pollution on the environment.

In the gas purifying device for energy saving and preventing spraying waste water indiscriminately of the present invention, a cross sectional area of the safe gas discharge channel after purification above the water line of the container can have a same or different size with the cross sectional area of the liquid container. The safe gas discharge channel can be equipped with or without a cover, and a cross sectional area of a narrowest part of the safe gas discharge channel with or without a cover provided thereon must be greater than a cross sectional area of a narrowest part of the waste gas incoming pipe before purification, and the greater the ratio therebetween, the less risk the waste water spraying out of the container to cause environment pollution. For example, a waste gas incoming pipe before purification with a suction exhauster provided thereon, has a incoming mouth. Besides a uniform cross sectional area of the waste gas incoming pipe through the length, sections with different cross sectional areas are also distributed thereon. For example, some sections have a largest cross sectional area of 1.5 m², other sections have a smallest cross sectional area of 1 m². However, the safe gas discharge channel after purification also has a uniform or non-uniform cross sectional area, and the cross sectional area of a narrowest part of the safe gas discharge channel after purification should be greater than the cross sectional area of the narrowest part of the waste gas incoming pipe before purification, e.g., the cross sectional area of a narrowest part of the safe gas discharge channel after purification is over 2 m². A specific appropriate ratio therebetween is selected according to the requirements of actual environment, e.g., for liquid having air bubble, the cross sectional area of the narrowest part of the waste gas incoming pipe after purification is required to be greater, so as to ensure that smooth operation function of the gas discharge channel is not impacted and avoid spraying waste water indiscriminately.

Preferably, in the gas purifying device for energy saving and preventing spraying waste water indiscriminately of the present invention, both the cross sectional area of a narrowest part of the safe gas discharge channel after purification and thereof the waste gas incoming pipe before purification are calculated by an over all cross sectional area of a position of a narrowest part of the channel, no matter the gas channel belonged thereof is a small hole with a filter screen or a channel without a filter screen. The cross sectional area of the gas discharge channel after purification is always greater than the cross sectional area of a narrowest part of the waste gas incoming pipe before purification, so as to ensure a smooth discharge operation is not impacted and prevent spraying waste water indiscriminately.

Preferably, the gas purifying device for energy saving and preventing spraying waste water indiscriminately of the present invention is made of metal such as stainless steel and iron sheet, concrete, plastic, other single material of metal or nonmetal or mixed material. Besides, the device of the present invention may use transparent materials for production.

The gas purifying device for energy saving and preventing spraying waste water indiscriminately according to another preferred embodiment of the present invention is illustrated, wherein the waste gas incoming pipe and the gas discharge channel further comprise a gas filter provided thereon, so as to improve the security of the device. The purified gas filter can be added by grains of sand, carbon and other materials, so as to further filter and purify gases.

The gas purifying device for energy saving and preventing spraying waste water indiscriminately according to another preferred embodiment of the present invention is characterized in that: the waste gas incoming pipe before purification of the container further comprises a water stop sheet provided on the water line, the installing manner of the water stop sheet is the same as thereof the eliminator, which extends from an inner edge of the water line of the channel to a space of the channel from bottom to top, in such a manner that the waste gas is capable of passing through the waste gas discharge channel, and that by taking advantage of the water stop sheet, the liquid of the container provided in a moving object is prevented from flowing into stoves which is a waste gas source, motor chambers or other objects avoiding water. The water stop sheet can adopt one layer or multi-layers.

The gas purifying device for energy saving and preventing spraying waste water indiscriminately according to another preferred embodiment of the present invention is illustrated, wherein according to requirements, a one-way valve which is capable of flowing out but not capable of flowing into is provided in the waste gas incoming pipe before purification, so as to prevent the liquid in the container provided on a moving object from flowing into stoves which is a waste gas source, motor chambers or other objects avoiding water, so as to ensure that a function of the original smooth operation of the gas discharge channel is not impacted.

The gas purifying device for energy saving and preventing spraying waste water indiscriminately according to another preferred embodiment of the present invention further comprises one or multiple suction exhausters provided above the water line before purification of the waste gas, in the liquid of the water line or on the waste gas incoming pipe 101 below the water line. The suction exhauster can adopt various effective types of split type or non-split type, such as centrifugal electric suction exhauster, blower, pump, hairdryer and etc. The suction exhauster is effective in helping the waste gas to discharge out of the waste gas discharge channel before purification into the purifying liquid below the water line in the container, so as to purify the waste gas, and then the waste gas is discharged out of the container freely. In the gas purifying device of the present invention, the suction exhauster is provided only on the waste gas incoming pipe before purification, but not on the gas discharge channel after purification above the water line directly, i.e., above the liquid in the container, so as to save electricity, prevent spraying the waste water out of the container to waste sources of water, so as to prevent the waste water from turning into waste gas and discharge out of the container to cause a secondary pollution on the environment. Since the gas purifying device must be installed in the room, accordingly the room should have appropriate ventilation channel for external gas and a gas discharge channel, wherein the gas discharge channel can be equipped with the suction exhauster, which will not cause spraying waste water indiscriminately of the purifying device of the present invention.

Preferably, the gas purifying device for energy saving and preventing spraying waste water indiscriminately according to another preferred embodiment of the present invention further comprises a monitoring facility for water quality and water level provided in the container.

The gas purifying device for energy saving and preventing spraying waste water indiscriminately according to another preferred embodiment of the present invention is illustrated, wherein an appropriate amount of foaming or non-foaming catalyst, i.e., waste gas cleaning agent is added to the purifying liquid in the container, such as dishwashing liquid, smoke washing liquid, deodorant or various materials for purifying, in such a manner that the purified gas is discharged out of the container which is harmless. In addition, the purifying liquid added by dishwashing liquid is especially effective in eliminating foul smell of the waste gas.

The gas purifying device for energy saving and preventing spraying waste water indiscriminately according to another preferred embodiment of the present invention is illustrated, wherein an appropriate amount of alkaline material and nitride is added to the purifying liquid in the container, so as to converting dioxins to other synthetic harmless substances, in such a manner that the purified gas is discharged out of the container which is harmless.

The gas purifying device for energy saving and preventing spraying waste water indiscriminately according to another preferred embodiment of the present invention is illustrated, wherein an appropriate amount of acidic material is added to the purifying liquid in the container, so as to neutralize alkaline material in the waste gas, in such a manner that the purified gas is discharged out of the container which is harmless.

The gas purifying device for energy saving and preventing spraying waste water indiscriminately according to another preferred embodiment of the present invention is illustrated, wherein the purifying liquid in the container can be water, fresh water, sea water, river water, well water and etc.

The gas purifying device for energy saving and preventing spraying waste water indiscriminately according to another preferred embodiment of the present invention is illustrated, wherein elements thereof can be produced or connected by screws or welding, and can be connected in a detachable manner.

The gas purifying device for energy saving and preventing spraying waste water indiscriminately according to another preferred embodiment of the present invention can be in series with conventional gas purifying device, so as to greatly change and improve efficiency of original gas purifying device.

The gas purifying device for energy saving and preventing spraying waste water indiscriminately according to another preferred embodiment of the present invention is illustrated, wherein recovered contaminant is converted to useful material for full application, e.g., recover dust is made into plant fertilizers or constructional materials, which is not only environmental friendly but also creates quantity of job opportunities for benefiting society.

In a method for preparing the gas purifying device according to a preferred embodiment of the present invention, a cross sectional area of the waste gas incoming pipe before purification can selectively have the same size through the whole length thereof. In addition, the cross sectional area of the waste gas incoming pipe before purification can also have a section with different size according to requirements.

In a method for preparing the gas purifying device according to another preferred embodiment of the present invention, the cross sectional area of the waste gas incoming pipe before purification can select one size, and can also adopt non-uniformity areas in each section according to requirements of actual environment.

The gas purifying device for energy saving and preventing spraying waste water indiscriminately according to another preferred embodiment of the present invention is illustrated, wherein the container thereof can select water pool, water slot, water tank and etc., which are equipped in an environment having tap water or other water source. Water treatment thereof can adopt automatic or non-automatic supporting facilities.

The gas purifying device for energy saving and preventing spraying waste water indiscriminately according to another preferred embodiment of the present invention is illustrated, wherein besides a cylinder shape and a cube shape shown in the drawings, the container for the purifying liquid can adopt other various kinds of shapes such as a cuboid.

According to another preferred embodiment of the present invention, the gas purifying device for energy saving and preventing spraying waste water indiscriminately can be configured according to discharge amount and discharge rate of gaseous pollutants generated by all walks of life from indoors or outdoors, and from various objects and environments. In the liquid container, both the safe gas discharge channel after purification and the waste gas incoming pipe before purification can be produced into shapes selective from the group consisting of a square shape, a round shape and a rectangular shape, or into types selective from the group consisting of a vertical type, an inclination type, a bending type and an expandable type, wherein both a single form and mixed form thereof can be selected.

In the technical solution of the gas purifying device for energy saving and preventing spraying waste water indiscriminately and method thereof of the present invention, whether or not the waste gas incoming pipe before purification in the liquid container has a water stop sheet, a suction exhauster or a gas filter, and whether the safe gas discharge channel after purification in the container of the purifying liquid has a upward, downward or horizontal eliminator, a gas filter, a breathable cover and etc, the cross sectional area of both the container and the safe gas discharge channel after purification should be greater than the cross sectional area of a narrowest part of the waste gas incoming pipe before purification, so as to disperse pressure of gas flow in the container and pressure of gas flow in the safe gas discharge channel after purification, which includes dispersing pressure of water vapor flow, preventing waste water in the container from spraying out of the container, avoiding polluting the environment and wasting water, and ensure that a smooth discharge function of the discharge channel is not impacted.

A method for energy saving and preventing spraying waste water indiscriminately, which is characterized in:

installing a suction exhauster in a channel of a waste gas discharge pipe before purification, wherein the suction exhauster is installed in and contacted with a liquid container from a mouth at a first end of a waste gas incoming pipe outside the container, and a mouth at a second end of a waste gas discharge channel which is submerged by liquid forces a waste gas flow to pump into purifying liquid in a container containing a proper quantity of purifying liquid, by taking advantage of interaction and full contaction of the gas flow and the purifying liquid in the liquid container, the gas flow is thoroughly filtered and purified, then purified gas is discharged out of the container from a safe gas discharge channel after purification which has a greater area than a narrowest part of the waste gas incoming pipe provided before the purifying liquid of the container, so as to ensure that the smooth discharge function of the discharge channel is not impacted, avoid wasting electricity, prevent the waste water from spraying out of the container to cause water waste, and avoid environmental pollution caused by the waste water.

In summary, main structure characteristics of the gas purifying device for energy saving and preventing spraying waste water indiscriminately of the present invention comprises a container containing a proper quantity of purifying liquid, a waste gas incoming pipe of the container having a the waste gas incoming mouth before purification which is provided in and contacted with the purifying liquid in the container and submerged by the purifying liquid. A cross sectional area of the safe gas discharge channel after purification is greater than the cross sectional area of the narrowest part of the waste gas incoming pipe provided before the purifying liquid in the container, so as to ensure that the original smooth operation of the discharge channel is not impacted. Taking advantage of the characteristics mentioned above, the gas purifying device solves problems, which people always hope to solve, but never be capable of solving, such as regular engine flameout due to the non-smooth gas discharge of a purifier and environmental pollution caused by spraying waste water indiscriminately in the purifier working process which results in that the cost of water wasted is greater that thereof the fuel. The gas purifying device of the present invention is a breakthrough and extremely important contribution to completely solve problems of waste gas pollution. The purifying device of the present invention has a simple structure, is convenient and practical to application. Foul smell from air of various environments can be absorbed and purified by the purifying device of the present invention, such as soot and dust, in such a manner that water source is saved, manufacture cost is saved, electricity is saved, and awareness of environmental protection is improved, in such a manner that quantity of living environment will be improved greatly and quickly.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1-19. (canceled)

20. A gas purifying device for energy saving and preventing spraying waste water indiscriminately, comprising:
a container containing a proper quantity of purifying liquid,
a slant type waste gas incoming pipe before purification having a channel mouth for introducing waste gas, which is contacted with the purifying liquid in the container, and is submerged by the purifying liquid, and
a safe gas discharge channel for purified gas, wherein a cross sectional area of a narrowest part of the safe gas discharge channel for purified gas is over one time greater than a narrowest part of the waste gas incoming pipe before purification.

21. The device, as recited in claim 20, wherein the device is made of metal, nonmetal or mixed materials.

22. The device, as recited in claim 20, wherein a gas filter is provided in the gas discharge channel.

23. The device, as recited in claim 20, wherein the waste gas incoming pipe having the channel mouth is communicated with various waste gases.

24. The device, as recited in claim 20, wherein an eliminator is provided above the purifying liquid and the safe gas discharge channel in the container, the eliminator is one layer or more than one layer, and after the eliminator is provided, a cross sectional area of the safe gas discharge channel is over one time greater than a narrowest part of the waste gas incoming pipe before purification.

25. The device, as recited in claim 20, further comprising an upper eliminator and a lower eliminator provided above the water line of the container, wherein separate spaces on an upper layer or a lower layer of the upper eliminator and the lower eliminator extend above or below each other, a cross sectional area of the gas discharge channel is over one time greater than a narrowest part of the waste gas incoming pipe before purification.

26. The device, as recited in claim 20, wherein a suction exhauster is provided in the waste gas incoming pipe before purification.

27. A method for energy saving and preventing spraying waste water indiscriminately, comprising steps of:
installing a suction exhauster in a channel of a waste gas discharge pipe before purification, wherein the suction exhauster is installed in and contacted with a liquid container from a mouth at a first end of a waste gas incoming pipe outside the container, and a mouth at a second end of a slant type waste gas discharge channel which is submerged by liquid and forces a waste gas flow to pump into purifying liquid in a container containing a proper quantity of purifying liquid, by taking advantage of interaction and full contaction of the gas flow and the purifying liquid in the liquid container, the gas flow is thoroughly filtered and purified, then purified gas is discharged out of the container from a safe gas discharge channel after purification which has an area over one time greater than a narrowest part of the waste gas incoming pipe before the purifying liquid of the container.
